(19) United States
(12) Patent Application Publication
(10) Pub. No.: US 2014/0275409 A1
(43) Pub. Date: Sep. 18, 2014

(54) HARD COATINGS CONTAINING GRAPHENIC CARBON PARTICLES

(71) Applicant: PPG INDUSTRIES OHIO, INC., Cleveland, OH (US)

(72) Inventors: Beverly Bendiksen, Coraopolis, PA (US); James E. Poole, Gibsonia, PA (US); David Johnson, McKeesport, PA (US)

(21) Appl. No.: 13/835,006

(22) Filed: Mar. 15, 2013

(51) Int. Cl. C09D 7/12

(52) U.S. Cl. CPC C09D 7/1216
USPC 524/590

(57) ABSTRACT

Hard coating compositions are disclosed containing graphenic carbon particles. The coating compositions include polymeric resins such as polyurethane or polyester with relatively small amounts of graphenic carbon particles that provide increased hardness.

### GOVERNMENT CONTRACT

This invention was made with United States government support under Air Force Research Laboratory Contract Number FA8650-05-D-55807 (Universal Technology Corporation), Subcontract 09-5568-076-01-C1 (Universal Technology Corporation to University of Dayton Research Institute), and Subcontract RSC09036 (University of Dayton Research Institute to PPG Industries, Inc.). The United States government has certain rights in this invention.

### FIELD OF THE INVENTION

The present invention relates to hard coatings containing graphenic carbon particles.

### BACKGROUND OF THE INVENTION

Many different types of coatings are subjected to environments where properties such as hardness and/or electrical conductivity are desired. For example, improved hardness or conductivity properties may be advantageous for various types of clear coatings and static dissipative coatings.

### SUMMARY OF THE INVENTION

An aspect of the invention provides a coating having increased hardness comprising a polymeric resin film, and graphenic carbon particles dispersed in the polymeric resin film, wherein the graphenic carbon particles comprise less than 15 weight percent of the coating based on the polymeric resin solids.

Another aspect of the invention provides a coating composition comprising a film-forming resin, and up to 15 weight percent graphenic carbon particles based on the total resin solids of the coating composition, wherein when the coating composition is cured it has a hardness greater than a hardness of the same coating composition without the graphenic carbon particles.

### BRIEF DESCRIPTION OF THE DRAWINGS

FIGS. 1 and 2 are graphs illustrating Fisher Microhardness properties for coatings containing graphenic carbon particles in accordance with embodiments of the present invention in comparison with coatings containing carbon black or graphite particles.

### DETAILED DESCRIPTION OF EMBODIMENTS OF THE INVENTION

In accordance with embodiments of the present invention, graphenic carbon particles are added to coating compositions to provide desirable properties such as increased hardness. The coating compositions can comprise any of a variety of thermoplastic and/or thermosetting compositions known in the art. For example, the coating compositions can comprise film-forming resins selected from epoxy resins, acrylic polymers, polyester polymers, polyurethane polymers, polyamide polymers, polyether polymers, bisphenol A based epoxy polymers, polysiloxane polymers, styrenes, ethylenes, butylenes, copolymers thereof, and mixtures thereof. Generally, these polymers can be any polymers of these types made by any method known to those skilled in the art. Such polymers may be solvent borne, water soluble or water dispersible, emulsifiable, or of limited water solubility. Furthermore, the polymers may be provided in sol gel systems, may be provided in core-shell polymer systems, or may be provided in powder form. In certain embodiments, the polymers are dispersions in a continuous phase comprising water and/or organic solvent, for example emulsion polymers or non-aqueous dispersions.

Thermosetting or curable coating compositions typically comprise film forming polymers or resins having functional groups that are reactive with either themselves or a crosslinking agent. The functional groups on the film-forming resin may be selected from any of a variety of reactive functional groups including, for example, carboxylic acid groups, amine groups, epoxide groups, hydroxyl groups, thiol groups, carbamate groups, amide groups, urea groups, isocyanate groups (including blocked isocyanate groups and tris-alkylcarbamoyltriazine) mercaptan groups, styrenic groups, anhydride groups, acetoacetate acrylates, uretidione and combinations thereof.

Thermosetting coating compositions typically comprise a crosslinking agent that may be selected from, for example, aminoplasts, polyisocyanates including blocked isocyanates, polyepoxides, beta-hydroxyalkylamides, polyacids, anhydrides, organometallic acid-functional materials, polyamines, polyamides, and mixtures of any of the foregoing. Suitable polyisocyanates include multifunctional isocyanates. Examples of multifunctional polyisocyanates include aliphatic diisocyanates like hexamethylene diisocyanate and isophorone diisocyanate, and aromatic diisocyanates like toluene diisocyanate and 4,4′-diphenylmethane diisocyanate. The polyisocyanates can be blocked or unblocked. Examples of other suitable polyisocyanates include isocyanurate trimers, allophanates, and uretdiones of diisocyanates. Examples of commercially available polyisocyanates include DESMODUR N3390, which is sold by Bayer Corporation, and TOLONATE HDT90, which is sold by Rhodia Inc. Suitable aminoplasts include condensates of amines and or amides with aldehyde. For example, the condensate of melamine with formaldehyde is a suitable aminoplast. Suitable aminoplasts are well known in the art. A suitable aminoplast is disclosed, for example, in U.S. Pat. No. 6,316,119 at column 5, lines 45-55, incorporated by reference herein. In certain embodiments, the resin can be self crosslinking. Self crosslinking means that the resin contains functional groups that are capable of reacting with themselves, such as alkoxysilane groups, or that the reaction product contains functional groups that are coreactive, for example hydroxyl groups and blocked isocyanate groups.

In certain embodiments, the graphenic carbon particles may be added to the film-forming resins in amounts of up to 10 or 15 weight percent based on the total coating solids. In certain embodiments, the hardness of the coatings is significantly increased with relatively minor additions of the graphenic carbon particles, for example, at graphenic carbon particle loadings of from 2 to 15 weight percent, or from 5 to 10 weight percent.

The dry film thickness of the cured coatings may typically range from 10 to 100 microns, for example, from 20 to 80 microns, 30 to 70 microns, or from 40 to 60 microns.

In accordance with certain embodiments, when the coating compositions are cured, the resultant coatings comprise a continuous matrix of the cured resin with graphenic carbon particles dispersed therein. The graphenic carbon particles may be dispersed uniformly throughout the thickness of the coating. Alternatively, the graphenic carbon particles may be distributed non-uniformly, e.g., with a particle distribution gradient through the thickness of the coating.

The graphenic carbon particles used in the coatings of the present invention may be obtained from commercial sources, for example, from Angstron, XG Sciences and other commercial sources. In certain embodiments discussed in detail below, the graphenic carbon particles may be produced in accordance with the methods and apparatus described in U.S. application Ser. Nos. 13/249,315 and 13/309,894, which are incorporated herein by reference.

As used herein, the term “graphenic carbon particles” means carbon particles having structures comprising one or more layers of one-atom-thick planar sheets of sp²-bonded carbon atoms that are densely packed in a honeycomb crystal lattice. The average number of stacked layers may be less than 100, for example, less than 50. In certain embodiments, the average number of stacked layers is 30 or less, such as 20 or less, 10 or less, or, in some cases, 5 or less. The graphenic carbon particles may be substantially flat, however, at least a portion of the planar sheets may be substantially curved, curled, creased or buckled. The particles typically do not have a spheroidal or equiaxed morphology.

In certain embodiments, the graphenic carbon particles present in the coating compositions of the present invention have a thickness, measured in a direction perpendicular to the carbon atom layers, of no more than 10 nanometers, no more than 5 nanometers, or, in certain embodiments, no more than 4 or 3 or 2 or 1 nanometers, such as no more than 3.6 nanometers. In certain embodiments, the graphenic carbon particles may be from 1 atom layer up to 3, 6, 9, 12, 20 or 30 atom layers thick, or more. In certain embodiments, the graphenic carbon particles present in the compositions of the present invention have a width and length, measured in a direction parallel to the carbon atoms layers, of at least 50 nanometers, such as more than 100 nanometers, in some cases more than 100 nanometers up to 500 nanometers, or more than 100 nanometers up to 200 nanometers. The graphenic carbon particles may be provided in the form of ultrathin flakes, platelets or sheets having relatively high aspect ratios (aspect ratio being defined as the ratio of the longest dimension of a particle to the shortest dimension of the particle) of greater than 3:1, such as greater than 10:1.

In certain embodiments, the graphenic carbon particles used in the coating compositions of the present invention have relatively low oxygen content. For example, the graphenic carbon particles used in certain embodiments of the compositions of the present invention may, even when having a thickness of no more than 5 or no more than 2 nanometers, have an oxygen content of no more than 2 atomic weight percent, such as no more than 1.5 or 1 atomic weight percent, or no more than 0.6 atomic weight, such as about 0.5 atomic weight percent. The oxygen content of the graphenic carbon particles can be determined using X-ray Photoelectron Spectroscopy, such as is described in D. R. Dreyer et al., Chem. Soc. Rev. 39, 228-240 (2010).

In certain embodiments, the graphenic carbon particles used in the coating compositions of the present invention have a B.E.T. specific surface area of at least 50 square meters per gram, such as 70 to 1000 square meters per gram, or, in some cases, 200 to 1000 square meters per grams or 200 to 400 square meters per gram. As used herein, the term “B.E.T. specific surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938).

In certain embodiments, the graphenic carbon particles used in the coating compositions of the present invention have a Raman spectroscopy 2D/G peak ratio of at least 1.1, for example, at least 1.2 or 1.3. As used herein, the term “2D/G peak ratio” refers to the ratio of the intensity of the 2D peak at 2692 cm⁻¹ to the intensity of the G peak at 1,580 cm⁻¹.

In certain embodiments, the graphenic carbon particles used in the coating compositions of the present invention have a relatively low bulk density. For example, the graphenic carbon particles used in certain embodiments of the present invention are characterized by having a bulk density (tap density) of less than 0.2 g/cm³, such as no more than 0.1 g/cm³. For the purposes of the present invention, the bulk density of the graphenic carbon particles is determined by placing 0.4 grams of the graphenic carbon particles in a glass measuring cylinder having a readable scale. The cylinder is raised approximately one-inch and tapped 100 times, by striking the base of the cylinder onto a hard surface, to allow the graphenic carbon particles to settle within the cylinder. The volume of the particles is then measured, and the bulk density is calculated by dividing 0.4 grams by the measured volume, wherein the bulk density is expressed in terms of g/cm³.

In certain embodiments, the graphenic carbon particles used in the coating compositions of the present invention have a compressed density and a percent densification that is less than the compressed density and percent densification of graphite powder and certain types of substantially flat graphenic carbon particles. Lower compressed density and lower percent densification are each currently believed to contribute to better dispersion and/or rheological properties than graphenic carbon particles exhibiting higher compressed density and higher percent densification. In certain embodiments, the compressed density of the graphenic carbon particles is 0.9 or less, such as less than 0.8, less than 0.7, such as from 0.6 to 0.7. In certain embodiments, the percent densification of the graphenic carbon particles is less than 40%, such as less than 30%, such as from 25 to 30%.

For purposes of the present invention, the compressed density of graphenic carbon particles is calculated from a measured thickness of a given mass of the particles after compression. Specifically, the measured thickness is determined by subjecting 0.1 grams of the graphenic carbon particles to cold press under 15,000 pound of force in a 1.3 centimeter die for 45 minutes, wherein the contact pressure is 500 MPa. The compressed density of the graphenic carbon particles is then calculated from this measured thickness according to the following equation:

$$Compressed Density ( g \text{/} {cm}^{3} ) = \frac{0.1 grams}{Π * {( 1.3 cm \text{/} 2 )}^{2} * ( measured thickness in cm )}$$

The percent densification of the graphenic carbon particles is then determined as the ratio of the calculated compressed density of the graphenic carbon particles, as determined above, to 2.2 g/cm³, which is the density of graphite.

In certain embodiments, the graphenic carbon particles have a measured bulk liquid conductivity of at least 100 microSiemens, such as at least 120 microSiemens, such as at least 140 microSiemens immediately after mixing and at later points in time, such as at 10 minutes, or 20 minutes, or 30 minutes, or 40 minutes. For the purposes of the present invention, the bulk liquid conductivity of the graphenic carbon particles is determined as follows. First, a sample comprising a 0.5% solution of graphenic carbon particles in butyl cellosolve is sonicated for 30 minutes with a bath sonicator. Immediately following sonication, the sample is placed in a standard calibrated electrolytic conductivity cell (K=1). A Fisher Scientific AB 30 conductivity meter is introduced to the sample to measure the conductivity of the sample. The conductivity is plotted over the course of about 40 minutes.

In accordance with certain embodiments, percolation, defined as long range interconnectivity, occurs between the conductive graphenic carbon particles. Such percolation may reduce the resistivity of the coating compositions. The conductive graphenic particles may occupy a minimum volume within the coating such that the particles form a continuous, or nearly continuous, network. In such a case, the aspect ratios of the graphenic carbon particles may affect the minimum volume required for percolation. Furthermore, the surface energy of the graphenic carbon particles may be the same or similar to the surface energy of the elastomeric rubber. Otherwise, the particles may tend to flocculate or demix as they are processed.

The graphenic carbon particles utilized in the coating compositions of the present invention can be made, for example, by thermal processes. In accordance with embodiments of the invention, thermally-produced graphenic carbon particles are made from carbon-containing precursor materials that are heated to high temperatures in a thermal zone such as a plasma. The carbon-containing precursor, such as a hydrocarbon provided in gaseous or liquid form, is heated in the thermal zone to produce the graphenic carbon particles in the thermal zone or downstream therefrom. For example, thermally-produced graphenic carbon particles may be made by the systems and methods disclosed in U.S. patent application Ser. Nos. 13/249,315 and 13/309,894.

In certain embodiments, the graphenic carbon particles may be made by using the apparatus and method described in U.S. patent application Ser. No. 13/249,315 at [0022] to [0048] in which (i) one or more hydrocarbon precursor materials capable of forming a two-carbon fragment species (such as n-propanol, ethane, ethylene, acetylene, vinyl chloride, 1,2-dichloroethane, allyl alcohol, propionaldehyde, and/or vinyl bromide) is introduced into a thermal zone (such as a plasma), and (ii) the hydrocarbon is heated in the thermal zone to a temperature of at least 1,000° C. to form the graphenic carbon particles. In other embodiments, the graphenic carbon particles may be made by using the apparatus and method described in U.S. patent application Ser. No. 13/309,894 at [0015] to [0042] in which (i) a methane precursor material (such as a material comprising at least 50 percent methane, or, in some cases, gaseous or liquid methane of at least 95 or 99 percent purity or higher) is introduced into a thermal zone (such as a plasma), and (ii) the methane precursor is heated in the thermal zone to form the graphenic carbon particles. Such methods can produce graphenic carbon particles having at least some, in some cases all, of the characteristics described above.

During production of the graphenic carbon particles by the thermal production methods described above, a carbon-containing precursor is provided as a feed material that may be contacted with an inert carrier gas. The carbon-containing precursor material may be heated in a thermal zone, for example, by a plasma system. In certain embodiments, the precursor material is heated to a temperature ranging from 1,000° C. to 20,000° C., such as 1,200° C. to 10,000° C. For example, the temperature of the thermal zone may range from 1,500 to 8,000° C., such as from 2,000 to 5,000° C. Although the thermal zone may be generated by a plasma system, it is to be understood that any other suitable heating system may be used to create the thermal zone, such as various types of furnaces including electrically heated tube furnaces and the like.

The gaseous stream may be contacted with one or more quench streams that are injected into the plasma chamber through at least one quench stream injection port. The quench stream may cool the gaseous stream to facilitate the formation or control the particle size or morphology of the graphenic carbon particles. In certain embodiments of the invention, after contacting the gaseous product stream with the quench streams, the ultrafine particles may be passed through a converging member. After the graphenic carbon particles exit the plasma system, they may be collected. Any suitable means may be used to separate the graphenic carbon particles from the gas flow, such as, for example, a bag filter, cyclone separator or deposition on a substrate.

Without being bound by any theory, it is currently believed that the foregoing methods of manufacturing graphenic carbon particles are particularly suitable for producing graphenic carbon particles having relatively low thickness and relatively high aspect ratio in combination with relatively low oxygen content, as described above. Moreover, such methods are currently believed to produce a substantial amount of graphenic carbon particles having a substantially curved, curled, creased or buckled morphology (referred to herein as a “3D” morphology), as opposed to producing predominantly particles having a substantially two-dimensional (or flat) morphology. This characteristic is believed to be reflected in the previously described compressed density characteristics and is believed to be beneficial in the present invention because, it is currently believed, when a significant portion of the graphenic carbon particles have a 3D morphology, “edge to edge” and “edge-to-face” contact between graphenic carbon particles within the composition may be promoted. This is thought to be because particles having a 3D morphology are less likely to be aggregated in the composition (due to lower Van der Waals forces) than particles having a two-dimensional morphology. Moreover, it is currently believed that even in the case of “face to face” contact between the particles having a 3D morphology, since the particles may have more than one facial plane, the entire particle surface is not engaged in a single “face to face” interaction with another single particle, but instead can participate in interactions with other particles, including other “face to face” interactions, in other planes. As a result, graphenic carbon particles having a 3D morphology are currently thought to provide the best conductive pathway in the present compositions and are currently thought to be useful for obtaining electrical conductivity characteristics sought by embodiments of the present invention, particularly when the graphenic carbon particles are present in the composition in relatively low amounts.

In addition to the resin and graphenic carbon particle components, the coatings of the present invention may include additional components conventionally added to coating compositions, such as cross-linkers, pigments, tints, flow aids, defoamers, dispersants, solvents, UV absorbers, catalysts and surface active agents.

In certain embodiments, the coating compositions are substantially free of certain components such as polyalkyleneimines, graphite, or other components. For example, the term “substantially free of polyalkyleneimines” means that polyalkyleneimines are not purposefully added, or are present as impurities or in trace amounts, e.g., less than 1 weight percent or less than 0.1 weight percent. Coatings of the present invention have been found to have good adhesion properties without the necessity of adding polyalkyleneimines. The term “substantially free of graphite” means that graphite is not purposefully added, or is present as an impurity or in trace amounts, e.g., less than 1 weight percent or less than 0.1 weight percent. In certain embodiments, graphite in minor amounts may be present in the coatings, e.g., less than 5 weight percent or less than 1 weight percent of the coating. If graphite is present, it is typically in an amount less than the graphene, e.g., less than 30 weight percent based on the combined weight of the graphite and graphene, for example, less than 20 or 10 weight percent.

The coating compositions of the present invention may be made by various standard methods in which the graphenic carbon particles are mixed with the film-forming resins and other components of the coating compositions. For example, for two-part coating systems, the graphenic carbon particles may be dispersed into part A and/or part B. In certain embodiments, the graphenic carbon particles are dispersed into part A by various mixing techniques such as sonication, high speed mixing, media milling and the like.

In accordance with certain embodiments, the coatings of the present invention possess desirable hardness properties. For example, polyurethane clearcoats including graphenic carbon particles in accordance with embodiments of the present invention may typically exhibit Fisher Microhardnesses of greater than 150, for example, greater than 160, greater than 170, or greater than 200 as measured by standard Fisher Microhardness testing. As used herein, the term “increased hardness”, when referring to coatings formed from the coating compositions of the present invention, means that a coating containing the graphenic carbon particles has a hardness that is measurably greater than the hardness of the same coating without the graphenic carbon particles. For example, in certain embodiments, the present coatings may have increased hardnesses that are at least 5 percent, or at least 10 percent, or at least 20 percent greater than the hardness of the same coating without the graphenic carbon particles, as measured by conventional coating hardness tests such as the standard Fisher Microhardness test.

In accordance with certain embodiments, the coatings of the present invention exhibit desired levels of electrical conductivity. For example, the coatings may have conductivities of greater than 0.002 S/m, for example, greater than 0.2 S/m, or greater than 300 S/m. The conductive coatings typically have sheet resistivities of less than 500 MΩ/sq, for example, less than 8 MΩ/sq. Sheet resistivity may be calculated by the following equation:

Sheet Resistivity,Ω/sq=4.5324 (V/I),

where V=millivolts and I=milliamps.

Conductivity may be calculated by the equation:

1/(Sheet Resistivity*Dry Film Thickness(cm)), in units of Ω⁻¹/cm.

Conversion to SI units (S/m) is obtained by the following equation:

Conductivity(S/m)=100×Conductivity(Ω⁻¹/cm)

In accordance with certain embodiments, the coatings do not exhibit significant electrical conductivity absent the addition of graphenic carbon particles. For example, a conventional refinish clearcoat may have a conductivity that is not measureable, while coatings of the present invention including graphenic carbon particles may exhibit conductivities of greater than 0.002 S/m, typically greater than 0.2 S/m. In certain embodiments, the addition of graphenic carbon particles increases conductivity of the coatings by greater than a factor of 10, typically greater than a factor of 1,000.

The following example is intended to illustrate various aspects of the invention, and is not intended to limit the scope of the invention.

### EXAMPLE

Graphenic carbon particles, carbon black or graphite particles were added to a polyurethane clear coat formulation comprising Deltron® DC4000 (Part A) and Deltron® DCH3085 (Part B Hardener) in a 4:1 ratio. The graphenic carbon particles were produced by the thermal plasma production method utilising methane as a precursor material disclosed in U.S. patent application Ser. No. 13/309,894. The carbon black was Raven 410 carbon black pigment. The graphite was Sigma Aldrich <20 μm graphite, Item #282863. Table 1 lists the components of the coating compositions.

TABLE 1

| | Weight (g) |
|---|---|
| Part A Components | |
| UV absorber 1 | 30-35 |
| UV absorber 2 | 45-50 |
| Surface Active Agent | 5-10 |
| Flow Aid | 1-5 |
| Acrylic Resin 1 | 1600-1700 |
| Polyester Resin | 40-50 |
| Catalyst 1 | 0.3-0.7 |
| Catalyst 2 | 0.3-0.7 |
| Acrylic Resin 2 | 750-800 |
| Acetone | 150-200 |
| Xylene | 550-600 |
| Dowanol PM | 250-300 |
| Methyl Isobutyl Ketone | 270-330 |
| Part B Components | |
| Polymeric Urethane Resin 1 | 370-430 |
| Polymeric Urethane Resin 2 | 120-180 |
| Catalyst | 0.5-1.0 |
| Polymeric Urethane Resin 3 | 100-150 |
| Methyl Amyl Ketone | 100-150 |
| Xylene | 25-75 |

An automotive refinish coating DC4000 was prepared according to the recommended Part A/Part B mixing ratio. The graphenic carbon, carbon black or graphite powder was bath-sonicated for 30 minutes into DC4000 Part A, added at 5 to 10 weight percent on a resin solids basis. Steel panels pretreated with Bonderite 1000 or 4×4×⅛ inch acrylic sheet pieces were sprayed with the coatings. The panels were subjected to two curing profiles. One set of panels was air dried at ambient conditions for seven days, and the second set of panels was cured in an oven for 30 minutes at 140° F.

Pencil hardness was tested according to the ASTM D3363 Standard Test Method for Film Hardness by Pencil Test. Fisher Microhardness was tested with a standard HM2000 instrument. Higher values denote harder coatings. All coatings were tested 7 days after spraying, regardless of type of cure.

The coating hardness results are listed below in Table 2.

TABLE 2
Hardness Test Results

| | | Particle | | | Fisher |
|---|---|---|---|---|---|
| Coating | | loading | | Pencil | Microhardness |
| Sample | Additive | (wt %) | Bake | hardness | HM-2000 |
| A1 | Control | 0 | 7 days/ | H | 123.1 |
| | | | ambient | | 130.1 |
| B1 | graphenic | 5 | 7 days/ | 2H | 167 |
| | carbon | | ambient | | 168.9 |
| C1 | graphenic | 10 | 7 days/ | 2H | >200 |
| | carbon | | ambient | | |
| A1 | Control | 0 | 30 min/ | 2H | 158 |
| | | | 140° F. | | 168.4 |
| B1 | graphenic | 5 | 30 min/ | 2H | 197 |
| | carbon | | 140° F. | | 186.2 |
| C1 | graphenic | 10 | 30 min/ | 2H | >200 |
| | carbon | | 140° F. | | |
| A2 | Control | 0 | 7 days/ | H | 124 |
| | | | ambient | | 137 |
| D1 | carbon | 5 | 7 days/ | H | 143 |
| | black | | ambient | | 157 |
| E1 | graphite | 5 | 7 days/ | 2H | 128 |
| | | | ambient | | 131 |
| A2 | Control | 0 | 30 min/ | H | 155 |
| | | | 140° F. | | 166 |
| D1 | carbon | 5 | 30 min/ | H | 158 |
| | black | | 140° F. | | 169 |
| E1 | graphite | 5 | 30 min/ | 2H | 165 |
| | | | 140° F. | | 161 |

FIGS. 1 and 2 graphically illustrate the increased hardness values of the coatings containing the graphenic carbon particles in accordance with the present invention in comparison with the carbon black-containing and graphite-containing coatings, at particle loadings of 5 weight percent based on resin solids. As shown in Table 2 and FIGS. 1 and 2, the addition of graphenic carbon particles significantly increased the hardness of the DC4000 coating over that of carbon black and graphite. The coating hardness, as measured by Fisher Microhardness, was increased by the graphenic carbon particles regardless of the type of cure.

The electrical properties of the films are then measured via a standard 4-probe conductivity test. Sheet resistivity was measured with a Jandel Equipment Four-Point Resistivity Meter. When power was applied to the four-point probe placed on the coated panel, the amps applied were recorded. If the coating was conductive, the millivolts were read in the display. The sheet resistivities of the coatings are listed below in Table 3.

TABLE 3
Electrical Conductivity Test Results

| | | Particle | | | | Sheet | Dry Film | |
|---|---|---|---|---|---|---|---|---|
| Coating | | loading | | Average | Current | Resistivity | Thickness | Conductivity |
| Sample | Additive | (wt %) | Bake | V (mV) | (μAmp) | (MΩ/sq) | (mils) | (S/m) |
| A2 | None | 0% | 7 days/ | no | any | off scale | N/A | not |
| | | | ambient | reading | | | | conductive |
| D1 | Carbon | 5% | 7 days/ | no | any | off scale | N/A | not |
| | Black | | ambient | reading | | | | conductive |
| E1 | SA | 5% | 7 days/ | no | any | off scale | N/A | not |
| | Graphite | | ambient | reading | | | | conductive |
| A1 | None | 0% | 7 days/ | no | any | off scale | N/A | not |
| | | | ambient | reading | | | | conductive |
| B1 | Graphenic | 5% | 7 days/ | 191 | 0.1 | 8.66 | 1.85 | 0.00246 |
| | carbon | | ambient | | | | | |
| C1 | Graphenic | 10% | 7 days/ | 16.6 | 1.0 | 752 | 2.39 | 0.219 |
| | carbon | | ambient | | | | | |
| A2 | None | 0% | 30′/ | no | any | off scale | — | not |
| | | | 140° F. | reading | | | | conductive |
| D1 | Carbon | 5% | 30′/ | no | any | off scale | — | not |
| | black | | 140° F. | reading | | | | conductive |
| E1 | SA | 5% | 30′/ | no | any | off scale | — | not |
| | Graphite | | 140° F. | reading | | | | conductive |
| A1 | None | 0% | 30′/ | no | any | off scale | — | not |
| | | | 140° F. | reading | | | | conductive |
| B1 | Graphenic | 5% | 30′/ | 78.5 | 0.1 | 3.56 | 1.85 | 0.00598 |
| | carbon | | 140° F. | | | | | |
| C1 | Graphenic | 10% | 30′/ | 9.2 | 1.0 | 417 | 2.39 | 0.395 |
| | carbon | | 140° F. | | | | | |

As shown in Table 3, only the coatings with the graphenic carbon particles were conductive at particle loadings of 5 weight percent based on resin solids.

For purposes of this detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A coating having increased hardness comprising:
a polymeric resin film; and
graphenic carbon particles dispersed in the polymeric resin film, wherein the graphenic carbon particles comprise less than 15 weight percent of the coating based on the polymeric resin solids.

2. The coating of claim 1, wherein the graphenic carbon particles comprise from 5 to 10 weight percent of the coating based on the polymeric resin solids.

3. The coating of claim 1, wherein the coating has an increased hardness of at least 10 percent greater than a hardness of the same coating without the graphenic carbon particles, as measured by Fisher Microhardness.

4. The coating of claim 1, wherein the polymeric resin comprises acrylic, polyester, polymeric aliphatic isocyanate resin, polyurethanes or a combination thereof.

5. The coating of claim 1, wherein the polymeric resin comprises polyester polyurethane.

6. The coating of claim 5, wherein the polyester polyurethane coating comprises less than 10 weight percent of the graphenic carbon particles and has a Fisher Microhardness of greater than 150.

7. The coating of claim 1, wherein the coating has a dry film thickness of from 20 to 80 microns.

8. A coating composition comprising:
a film-forming resin; and
up to 15 weight percent graphenic carbon particles based on the total resin solids of the coating composition, wherein when the coating composition is cured it has a hardness greater than a hardness of the same coating composition without the graphenic carbon particles.

9. The coating composition of claim 8, wherein the graphenic carbon particles comprise from 5 to 10 weight percent based on the polymeric resin solids.

10. The coating composition of claim 8, wherein the polymeric resin comprises acrylic, polyester, polymeric aliphatic isocyanate resin, polyurethanes or a combination thereof.

11. The coating composition of claim 8, wherein the polymeric resin comprises polyester polyurethane.

12. The coating composition of claim 8, wherein the resin comprises part A of a two-part coating system.
